(19) United States
(12) Patent Application Publication
(10) Pub. No.: US 2005/0231191 A1
(43) Pub. Date: Oct. 20, 2005

(54) TACHOMETER PULSE DETECTION METHOD AND CIRCUIT

(75) Inventor: Mitsuru Tsuji, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (JP)

(21) Appl. No.: 10/907,435

(22) Filed: Mar. 31, 2005

(30) Foreign Application Priority Data
Apr. 15, 2004 (JP) 2004-119798

(51) Int. Cl. G01P 3/48

(52) U.S. Cl. 324/164

(57) ABSTRACT

An improved and simplified method and circuit for generating square wave pulses each of which is transmitted to a tachometer circuit be starting the generation upon the receipt of a beginning signal of a first value from either a sensor coil or a generator associated with an engine shaft and terminating the generation upon the receipt of a ending signal of a second value. The first and second values may be either the same or different.

This invention relates to a tachometer pulse detection method and circuit and more particularly to one that is less sensitive to electrical noise and is more adaptable to use with a variety of generating systems.

As is well known, many forms of engine control require instantaneous measurement of engine speed, particularly where the engine propels a vehicle be it land, water or air borne. The engine speed is often used as a parameter in fuel control as well as spark control in spark ignited engines. In addition frequently the operator is provided visually with an indication of engine speed by a tachometer to assist in operation ov the vehicle and its engine.

The speed is sensed normally by a tachometer detection circuit that senses engine rotational speed and outputs a speed signal. The speed is sensed by a pulser coil that cooperates with one or more timing marks carried by a shaft of the engine such as its output shaft or a shaft that rotates in timed relation to the output shaft. This signal is processed by a CPU and is transmitted to the various engine controls and a digital or analog tachometer if the vehicle is so equipped.

FIGS. 1A through 1D show the types of pulses involved in these devices. FIG. 1A shows the resulting pulse output of the tachometer drive circuit that is comprised of a series of square wave pulses generated during a single rotation of the shaft being monitored. FIGS. 1B, 1C and 1D show the actual pulse shape generated by the sensor and transmitted to the tachometer drive circuit from which the pulses shown in FIG. 1A are derived.

FIG. 2 shows a typical prior art type tachometer drive circuit. Rectangular pulses, shaped as shown in FIG. 1A, from a pulser coil are normally inputted into, and counted by, a conventional tachometer, as used, for example in Japanese Published applications Hei 6-331637(A) and Hei 7-311209(A). In cases where the tachometer pulses are sent to the detection circuit via a ECU, the tachometer pulses detected are in the form of rectangular pulses such as shown in FIG. 1A. Therefore, the detection circuit such as shown in FIG. 2 can be used to count the number of rotations with an on-off circuit activated by a transistor, and the resulting data will be sent to the CPU to be processed.

When this is done, in order to identify each single pulse, the rising and falling edges of each pulse from the leading and trailing ends of the timing mark are detected and recognized as constituting one pulse. Then, such pulses are counted in a time period to calculate the number of engine rotations. Specifically, in cases where the tachometer pulses are rectangular pulses such as shown in FIG. 1A, a voltage of about 2-3V, which is slightly higher than a bottom voltage V_{L} (about 1 V) of the pulses, is used as a threshold value as a detection voltage for the rising and falling edges, to identify each individual pulse. In this way, respective pulses can be identified and the number of the pulses can be counted.

However, in cases where the tachometer pulses outputted from a coil of a magneto generator of the engine rather than utilizing a single timing mark are sent directly to the detection circuit, none of the resulting three patterns of output waveforms involve rectangular pulses. For example, depending on the construction of the generator, there may comprise two, three or six pulses for one rotation of the shaft as shown in FIGS. 1B, 1C and 1D. Therefore, the output waveforms need to be shaped to allow recognition and counting of the respective pulses, in order for the CPU to process the data.

In particular, the waveform of a type generating three pulses for one rotation of the crankshaft such as shown in FIG. 1C, includes noise. When such a waveform is sent to the detection circuit, a simple on-off circuit cannot count the correct number of rotations, for the reasons now to be stated.

FIG. 3A is a waveform graph of a tachometer pulse including noise, showing in detail the portion P of FIG. 1C. The three tachometer pulse waveforms of FIG. 1C are each formed with a noise pulse P_{N} and a genuine pulse P_{G}, as shown in FIG. 3A. A peak voltage Vb and a lower voltage Vc of the noise pulse P_{N} are respectively about 12V and about 2V. In the case of such a tachometer pulse including noise, a threshold voltage for pulse identification is set to about 2 to 3V. in a similar manner, it is necessary to set the threshold voltage is higher than the lower voltage Vc of the noise pulse P_{N}. Therefore, rising and falling edges of the noise are detected respectively in a section beginning at the point b and ending at c and identified as constituting one noise pulse, and thereafter, rising and falling edges of the genuine pulse are detected. Thus, two pulse waveforms must be identified from one actual tachometer pulse, one noise and one actual. The total time involved is shown in FIG. 3B while the time period of actually useful information is shown in FIG. 3C

Also, the tachometer pulses shaped by the ECU from a timing mark are outputted at voltages around 10V, while those from the output of a magneto are outputted at voltages of 240V through 280V. Therefore, it is conventionally necessary to use a detection circuit adapted to voltages of either ECU sensed timing marks or magnetos.

It is therefore a principal object of the invention to provide a tachometer sensing method and circuit that eliminates the problem of noise and is adaptable to various types of timing sensor arrangements.

### SUMMARY OF THE INVENTION

A first feature of the invention is adapted to be embodied in a method of generating tachometer pulse signals from generated square wave pulses from a rotating shaft element of an internal combustion engine such as either of a timing mark and sensor coil or a generator and regardless of electrical noise. The method comprises the steps of setting a threshold value for the beginning of generating an output pulse of square form and desired magnitude and maintaining that output until the sensing of a set threshold value for the ending of the generation of the output pulse and discontinuing the output of the square wave at that time and transmitting each generated output pulse to a tachometer circuit.

Another feature of the invention is adapted to be embodied in a tachometer generating circuit for generating square wave pulses from a rotating shaft element of an internal combustion engine such as either of a timing mark and sensor coil or a generator and regardless of electrical noise. The circuit comprises a square wave generator for generating square waves upon the receipt of starting and ending signals. A sensor senses a voltage wave form from either the sensor coil or the generator. An initiating circuit issues an initiating signal to the square wave generator upon the receipt of a voltage of a first magnitude and discontinues the output of the square wave upon the receipt of a voltage of a second magnitude. Each generated output pulse is delivered to a tachometer circuit.

### BRIEF DESCRIPTION OF THE DRAWINGS

FIGS. 1A-1D are graphical views showing the wave form patterns encountered in the various types of tachometer signal generating apparatus.

FIG. 2 is a schematic electrical diagram of a prior art type of tachometer generating signal apparatus.

FIGS. 3A-3C are graphical views showing both the prior art signals and how they can be used to practice the embodiments of the invention.

FIG. 4 is a block diagram of a tachometer and its signal generating apparatus operating in accordance with the invention.

FIG. 5 is a circuit diagram of an electrical circuit embodying the invention.

FIGS. 6A and 6B are graphical views showing how an embodiment of the invention processes the signals to achieve the objects of the invention.

### DETAILED DESCRIPTION

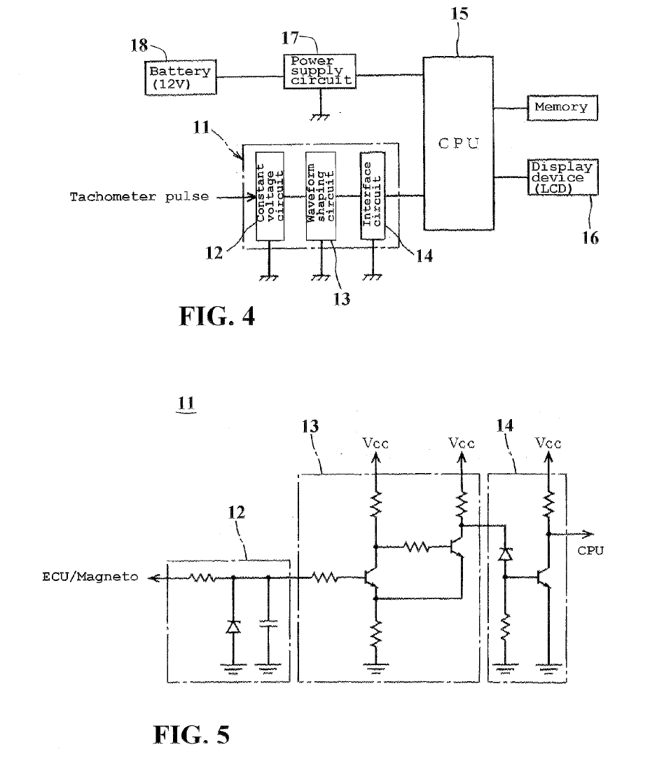

Referring now in detail to the drawings and initially to FIG. 4 this shows schematically a tachometer having a tachometer pulse detection circuit 11 constructed in accordance with the invention. A tachometer pulse, or a signal representing rotations of an engine, is outputted from either a timing sensor or a magneto, and inputted to the tachometer pulse detection circuit 11. The tachometer pulse detection circuit 11 includes a constant voltage circuit 12, a waveform shaping circuit 13 and an interface circuit 14.

The number of rotations of the engine counted by the tachometer pulse detection circuit 11 is sent to a CPU 15, which, connected to a memory and the like, processes the data. A display device 16 such as an LCD or analog type displays the engine speed. These circuits and devices are respectively powered by, for example, a power supply circuit 17 connected to a 12V on-board battery 18, and provided with as much electricity as they need to operate (for example, 5V for the CPU 15).

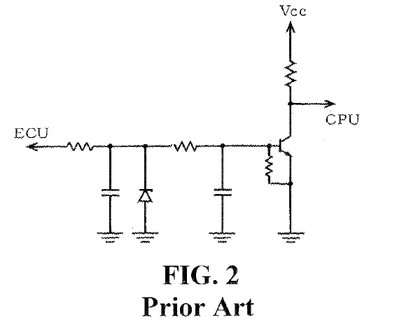

FIG. 2 shows an embodiment of the tachometer pulse detection circuit 11 of the present invention. The tachometer pulse detection circuit 11 includes a constant voltage circuit 12 having a resistor of several kΩ and a Zener diode, a waveform shaping circuit 13 with a Schmitt trigger circuit, and an interface circuit 14 for converting into a signal to be inputted in the CPU 15.

In the tachometer pulse detection circuit 11, tachometer pulses are first inputted in the constant voltage circuit 12. This configuration allows absorption of high voltages and conversion of them into a predetermined voltage and ensures subsequent stable operation of the circuit, even when voltages inputted in the tachometer pulse detection circuit 11 greatly differ, depending on the tachometer pulse input conditions. As examples the input voltage for tachometer pulses inputted via the pulse from a timing detector is about 9.5V while the input voltage for those inputted from the magneto is 280V.

Each of the resistors used in the waveform shaping circuit 13 has a resistance value corresponding to the detection voltage value for rising and falling edges of a tachometer pulse waveform, which is set so as not to cause erroneous detection of noise based on the tachometer pulse waveform and the voltage value at each point on the waveform obtained in a preliminary experiment on each engine. Thus, the number of actual pulses only is counted for the tachometer pulses inputted in the waveform shaping circuit 13 via the constant voltage circuit 12, without erroneous detection of noise as a pulse, and the actual number of the pulses is sent to the interface circuit 14.

The interface circuit 14 converts the shaped tachometer pulses further into rectangular pulses of 0/5V, and sends the converted pulse signal to the CPU 15.

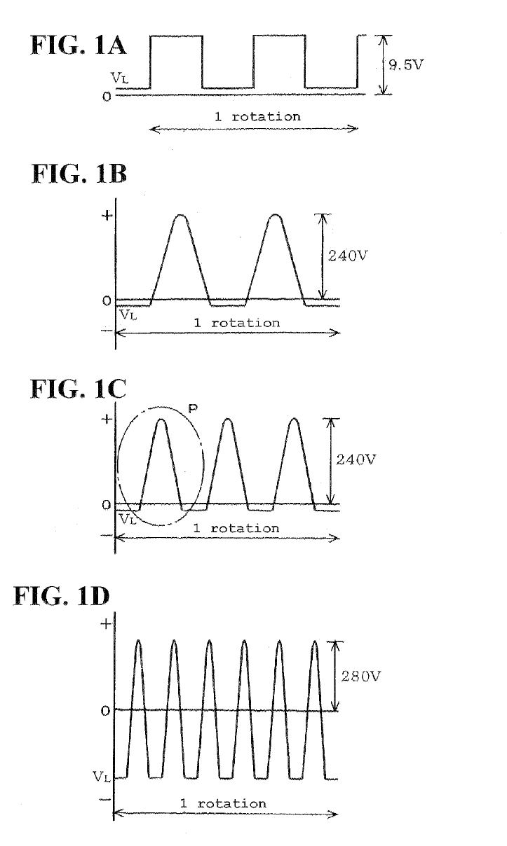

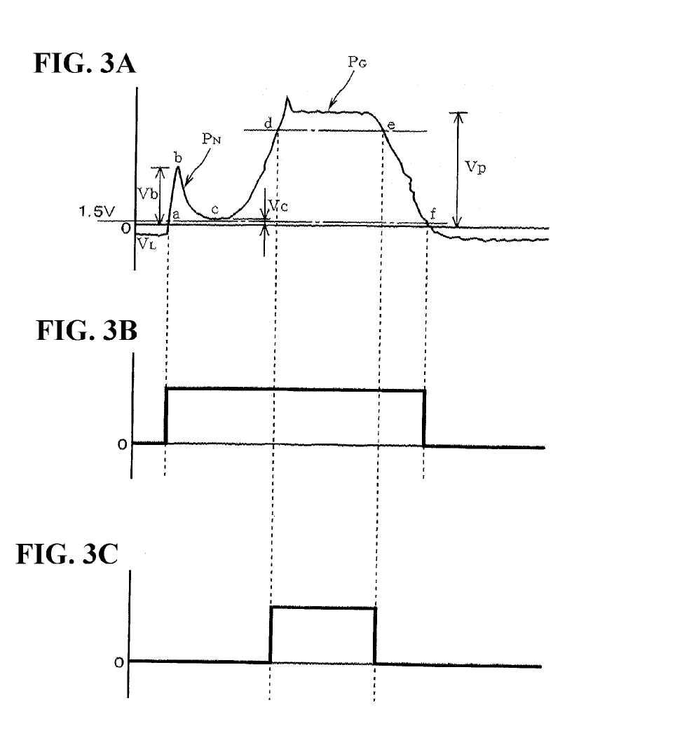

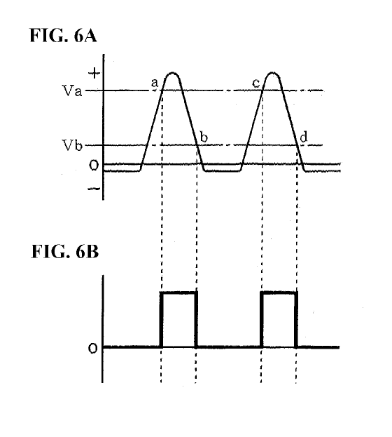

By way of a first example a description will be made of an embodiment where the tachometer pulse detection circuit 11 shapes a waveform in which one rotation of a crankshaft corresponds to three pulses, as shown in FIG. 1C. Referring to FIG. 6A, this specifically shows the portion P of FIG. 1C and conforms to the trace shown in FIG. 3A. The pulse waveform for one cycle includes noise indicated at P_{N} in FIG. 3A. As previously noted by reference to that figure, the voltage due to the noise appears in an initial portion of the waveform, and when the voltage reduces from a maximum voltage Vb to a voltage Vc, actual tachometer pulses due to engine rotations appear in the waveform.

On an assumption that the voltage V_{c} is 2V, for example, in a preliminary experiment on the engine in which the voltages at respective points on the waveform shown in FIG. 3A are measured, the waveform shaping circuit 13 is configured with the detection voltages for rising and falling edges both set to 1.5V, for example.

In this case, the waveform shaping circuit 13 detects, at a point a where the input voltage due to noise reaches 1.5V, the voltage for a rising edge and determines that a pulse has started. The waveform shaping circuit 13 does not detect, at a point c where the noise is suppressed, that the voltage has decreased. Thereafter, an actual tachometer pulse is inputted. The waveform shaping circuit 13 detects, at a point f where the voltage due to the tachometer pulse decreases to 1.5V, the voltage for a falling edge and determines that the pulse has ended.

Thus, in cases where the detection voltages for the rising and falling edges are both set to 1.5V, a rising edge is counted when the noise starts while a falling edge is not detected until the pulse due to the actual rotation of the engine is settled. That is, one pulse is counted to have occurred during a period from the point a to the point f, as shown in FIG. 3B, and thus it is possible to avoid counting more pulses than the actual number of engine rotations under the influence of the noise.

A second embodiment of the invention will now be described by reference to FIGS. 3A and 3C. It is assumed for example and for the same waveform as in the first embodiment that the maximum voltage V_{b} of the noise is 12V and a voltage Vₚ of the actual tachometer pulse is 16V, for example, and that the detection voltages for rising and falling edges are set to 15V, or the voltage at points d and e, respectively. Then, the waveform shaping circuit 13 does not detect any voltage at the occurrence of the noise, but detects at the point d a rising edge of the voltage and determines that a pulse has started, and then detects at the point e a falling edge of the voltage and determines that the pulse has ended. Thus, in this case, a voltage is not detected for the noise, and one pulse is counted to have occurred during a period of time between the point d and the point e, as shown in FIG. 3C.

It should be noted that that the detection voltages for rising and falling edges may be set independently within the scope of the invention rather than at the same value as in the described first and second embodiments.

FIGS. 6A and 6B shows a further embodiment wherein the waveform shaping circuit 13 can shape even a curved waveform which is less likely to involve noise, such as shown in FIG. 1B, into rectangular pulses. As shown in FIG. 6A, the detection voltage for the rising edge and that for the falling edge are set to a voltage Vₐ and a voltage V_{b}, respectively. Then, a rising edge of the voltage is detected and it is determined that a pulse has started at a point a, while a falling edge of the voltage is detected at a point b and it is determined that the pulse has ended. In this manner, the waveform is shaped into rectangular pulses such as shown in FIG. 6B. Such threshold voltages for rising and falling edges can be adjusted by changing the resistances and transistor characteristics of the Schmitt trigger circuit 13 of FIGS. 4 and 5

Thus from the foregoing description it should be apparent that the described circuits and methods that rectangular shaped wave forms can be easily generated and processed from a variety of wave forms generated by a rotating shaft element such as a timing mark and pulser coil or the output of one or more generator coils regardless of noise or the generated voltage and without the necessity of counting unused pulses. Of course those skilled in the art will readily understand that the described embodiments are only exemplary of forms that the invention may take and that various changes and modifications may be made without departing from the spirit and scope of the invention, as defined by the appended claims.

1. A method of generating square wave pulses from a rotating shaft element of an internal combustion engine such as either of a timing mark and sensor coil or a generator and regardless of electrical noise comprising the steps of setting a threshold value for the beginning of generating an output pulse of square form and desired magnitude and maintaining that output until the sensing of a set threshold value for the ending of the generation of the output pulse and discontinuing the output of the square wave at that time and transmitting each generated output pulse to a tachometer circuit.

2. The method as set forth in claim 1 wherein the set threshold values are the same.

3. The method as set forth in claim 1 wherein the set threshold values are not the same.

4. The method as set forth in claim 3 wherein the set beginning threshold value is less than the set ending threshold value.

5. A tachometer generating circuit for generating square wave pulses from a rotating shaft element of an internal combustion engine such as either of a timing mark and sensor coil or a generator and regardless of electrical noise comprising a square wave generator for generating square waves upon the receipt of starting and ending signals, a sensor for sensing a voltage wave form from either the sensor coil or the generator, an initiating circuit for issuing an initiating signal to said square wave generator upon the receipt of a voltage of a first magnitude and discontinuing the output of the square wave upon the receipt of a voltage of a second magnitude and transmitting each generated output pulse to a tachometer circuit.

6. A tachometer generating circuit as set forth in claim 5 wherein the set threshold values are the same.

7. A tachometer generating circuit as set forth in claim 5 wherein the set threshold values are not the same.

8. A tachometer generating circuit as set forth in claim 7 wherein the set beginning threshold value is less than the set ending threshold value.

9. A tachometer generating circuit as set forth in claim 5 wherein the beginning and ending signals are generated by a circuit including a resistor and a Zener diode.

10. A tachometer generating circuit as set forth in claim 5 wherein square wave generator is comprised of a Schmitt trigger circuit.

11. A tachometer generating circuit as set forth in claim 10 wherein the beginning and ending signals are generated by a circuit including a resistor and a Zener diode.
